(19) United States
(12) Patent Application Publication
(10) Pub. No.: US 2026/0322625 A1
(43) Pub. Date: Oct. 15, 2026

(54) METHOD AND APPARATUS FOR MANAGING AND PROVISIONING DIVERSE PKI STRUCTURES ACROSS MULTI-DOMAIN DEPLOYMENTS

(71) Applicant: ARRIS Enterprises LLC, Horsham, PA (US)

(72) Inventors: Jinsong ZHENG, San Diego, CA (US); Xin QIU, San Diego, CA (US); Oscar JIANG, West Covina, CA (US); Jason PASION, San Diego, CA (US)

(73) Assignee: ARRIS Enterprises LLC, Horsham, PA (US)

(21) Appl. No.: 19/641,261

(22) Filed: Apr. 7, 2026

Related U.S. Application Data
(60) Provisional application No. 63/786,863, filed on Apr. 10, 2025.

(51) Int. Cl. H04L 9/32; H04L 9/08

(52) U.S. Cl. CPC H04L 9/3265; H04L 9/0836

(57) ABSTRACT

A method and apparatus for provisioning credentials to a remote device is disclosed. In one embodiment, the method comprises receiving information describing a PKI hierarchical structure of one or more hierarchical PKI structures, generating a configuration package including a chain of credentials, the configuration package uniquely associated with a random provision parameter, receiving a credential request, the credential request having a certificate signing request (CSR) and the provision parameter, validating the CSR; and providing the signed device digital certificate only if the credential request is validated.

### CROSS-REFERENCE TO RELATED APPLICATIONS

This application is related to U.S. Provisional Patent Application No. 63/786,863, entitled “Framework for Managing and Provisioning Diverse PKI Structures Across Multi-Domain Deployments,” by Jinsong Zheng, Xin Qiu, Oscar Jiang, and Jason Pasion, filed Apr. 10, 2025, which application is hereby incorporated by reference herein.

### BACKGROUND

### Field

The present disclosure relates to systems and methods for providing credentials to devices.

### 2. Description of the Related Art

Modern devices are highly interconnected through a network of technologies that enable them to communicate, share data, and work seamlessly together. Many devices store data or perform computations via the cloud, enabling remote access, synchronization, and backup. A smart home or office is an example of a connected ecosystem, where devices like smart thermostats, lights, security cameras, and voice assistants like AMAZON ALEXA or GOOGLE ASSISTANT can work together. For instance, you can adjust your thermostat via your smartphone, and your lights can turn on automatically when you enter a room.

Devices can also share data with each other. For example, a fitness tracker might synchronize with a smartphone app to track activity, or a smartwatch might send notifications from your phone. Many modern devices use artificial intelligence (AI) to automate tasks and make intelligent decisions based on data. For example, smart speakers can learn your preferences and adjust settings automatically, while self-driving cars use sensors and AI to communicate with their environment.

### SUMMARY

To address the requirements described above, this document discloses a system and method for provisioning digital certificates in a system having one or more PKI (Public Key Infrastructure) hierarchical structures, also known as PKI certificate hierarchical structures or certificate hierarchies, each PKI hierarchical structure having one or more certificate chains.

A certificate chain is an ordered list of certificates that enable the receiver to verify that the sender and all CAs are trustworthy. The certificate chain begins with the device certificate and each certificate is signed by the entity identified by the next certificate in the chain, ending with the certificate signed by a Root CA. Each certificate chain starts from a root CA (Certificate Authority), through sat least one level of subordinate CAs (sub CAs), ends with a device certificate.

In one embodiment, the method comprises receiving information describing receiving information describing a desired PKI hierarchical structure of the one or more PKI hierarchical structures, the PKI hierarchical structure having chain of credentials having a root certificate authority (CA) certificate, one or more subordinate CA certificates, and a device certificate; generating a configuration package, and uniquely associating the configuration package with a random provision parameter. The configuration package includes information identifying the root CA, each of the one or more sub-CAs in the PKI hierarchical structure, and a device certificate profile.

When a credential such as a device certificate is desired, a request for a the credential is received from the entity desiring the credential. The request is validated by the PKI service, and if the validation succeeds, the requested credential is provided.

Another embodiment is evidenced by an apparatus having a processor and a communicatively coupled memory storing processor instructions for performing the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram illustrating a device operating in multiple environments or domains using PKI;

FIG. 2 is an illustration of multiple PKI certificate hierarchical structures;

FIG. 3 is a diagram illustrating multiple certificate chains such as certificate chains being mapped one-to-one to a random unique data type IDs by a PKI service provider;

FIG. 4 is a diagram illustrating a PKI service provider accepting a credential request having a type ID, and providing a credential associated with a certificate chain identified by that type ID;

FIG. 5 is a diagram illustrating one embodiment of exemplary operations that can be used to provision digital certificates to a device;

FIG. 6 presents a diagram illustrating the flow of information between the PKI customer, the PKI Service Provider, Root CAs and Sub-CAs, and the device;

FIG. 7 is a diagram depicting one embodiment of exemplary operations that can be used to receive information describing the PKI hierarchical structure; and

FIG. 8 illustrates an exemplary computer system that could be used to implement processing elements.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### OVERVIEW

### Multi-Domain Deployments

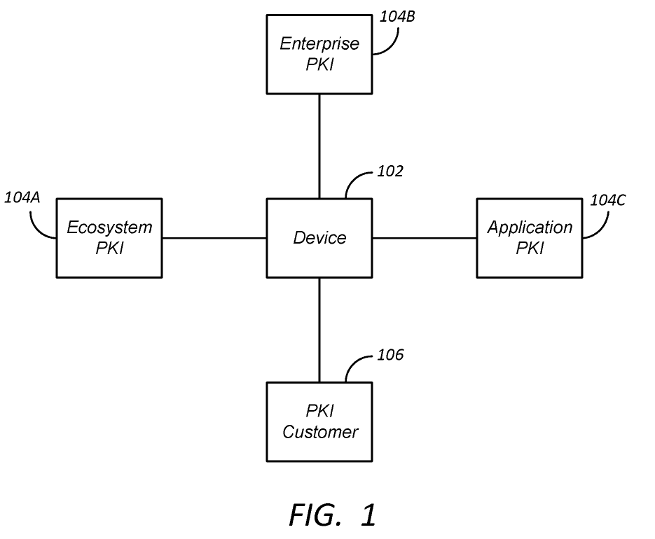

FIG. 1 is a diagram illustrating a device operating in multiple environments or domains using PKI. The device 102 may comprise a smart wearable device 102 such as a fitness tracker or smart watch, but may comprise any device that uses or requires credentials to operate.

With more and more powerful hardware available in highly portable devices 102, a single device 102 may have the capability of operating in more than one environment or domain. For example, a device may interact with the PKI of one or more ecosystems 104A such as IPHONE in the APPLE HEALTH KIT eco-system, with an ANDROID phone in the GOOGLE FIT eco-system, and with a FITBIT ecosystem. In addition, if the same fitness tracker may be operated as part of one or more enterprise system PKIs (such as WALMART’s enterprise system), it may interact with a computer server supporting the program, and needs to be authenticated within that PKI to ensure the device is registered and properly tracked. Meanwhile, the same fitness tracker may run a third-party health monitoring app. Deploying a device in more than one domain can be referred to as “multi-domain deployments.”

### Importance of Device Identity and Data Security

In the world of connected devices, device identity and security are paramount for ensuring the trustworthiness, functionality, and safety of the entire environment such devices operate in. Device identity refers to the unique identification of each device within a network. Just like humans have identity documents (like a driver’s license), connected devices require mechanisms to authenticate their identity to ensure that only legitimate, authorized devices can join the network or access sensitive data. Device identity plays a crucial role in confirming that a device is who or what it claims to be. Without proper authentication, malicious devices could impersonate legitimate ones, gaining unauthorized access to networks or sensitive data. By assigning unique identities to devices, organizations and individuals can enforce policies to restrict access based on the device's authenticity and role. For example, only certain devices (like a trusted smartphone or smart thermostat) might be allowed to interact with other devices in a smart home or corporate network. Proper device identification helps track devices' actions in the network, making it easier to monitor, audit, and detect unusual or malicious behavior.

With millions of devices connected to each other and to the internet, security becomes a critical concern. If a device is compromised, it can be used to launch attacks, steal data, or spread malware. As devices become more integrated into everyday life - controlling homes, vehicles, and even health-related functions - securing them is essential. Connected devices collect and transmit large amounts of personal, financial, and operational data. If not properly secured on devices or in transit, this data is vulnerable to interception, theft, or alteration, leading to privacy breaches, identity theft, unauthorized access, distributed attacks, and regulatory noncompliance, among other consequences.

### Need for Multiple Device Identities in Multiple Domains

As a device deployed to multiple domains might perform different functions and interact with other elements in those domains in different ways, it might need different kinds of identities to be interoperable with other elements. For example, in a device management domain, a device’s serial number might be needed. Meanwhile, the same device in a fitness app ecosystem may need an assigned device name. This is analogous to the same person needing different identification documents for different purposes, for example a driver’s license for driving vehicles and a passport for foreign travel.

Traditionally, a device would acquire a certain device identity when it is manufactured in a factory, usually for the device’s initial deployment. For example, if a device is known to be deployed to a Walmart enterprise domain, the device would acquire a device identifier (ID) required by the WALMART enterprise domain. Meanwhile, if another device is known to be deployed to the APPLE HEALTH KIT ecosystem, it would acquire a device ID required by the APPLE HEALTH KIT ecosystem. Typically, devices with different factory configurations, even if the only difference is in their kinds of device identifier, different Stock Keeping Units (SKUs) would be created to track them through the manufacturing, shipping, deployment, warranty, repair, and possibly other processes.

To address the need for strong device identities, secure data storage and communication, and multiple device identities in multiple domains, described below is a system, method and apparatus in which (1) multiple device identities of the same device are in multiple digital certificates on the device, (2) different device certificates of a device are in different certificate chains, which may or may not have common elements in them, (3) different certificate chains are configured in a PKI service provider’s system by the parties that need to obtain different kinds of device certificates with different kinds of device identity. Such parties are called PKI service customers in the context of PKI services, and (4) each certificate chain is assigned a random unique data type identifier (data type ID), which is used in the provisioning of certificates in the corresponding chain.

With this framework, PKI service providers can effectively serve the certificate provisioning needs of PKI service customers, such as device manufacturers, resellers, operators, etc., who need multiple strong device identities in different domains at different deployment moments, while such customers can reduce the number of stock keeping units (SKUs) to use and improve scalability across variations in product configuration, device application and target operating environment. SKUs are unique alphanumeric codes that are assigned to each of its products to distinguish them from each other and manage inventory, for example, batches of devices. Since strong device identities can be readily provided by the credentials described above and the credentials are associated by type IDs, the batch-identifying functionality of SKUs can be achieved instead with the supplied credentials, thus decreasing the number of required SKUs.

### Multiple Strong Device IDs in Certificates in Multiple PKI Structures

The framework uses multiple digital certificates on a device as proof of multiple device identities of the devices that are needed by the multiple domains the device is deployed to. Such certificates can be in one or more PKI structures or certificate hierarchies. A PKI structure or certificate hierarchy is a tree-like model to establish trust across a network.

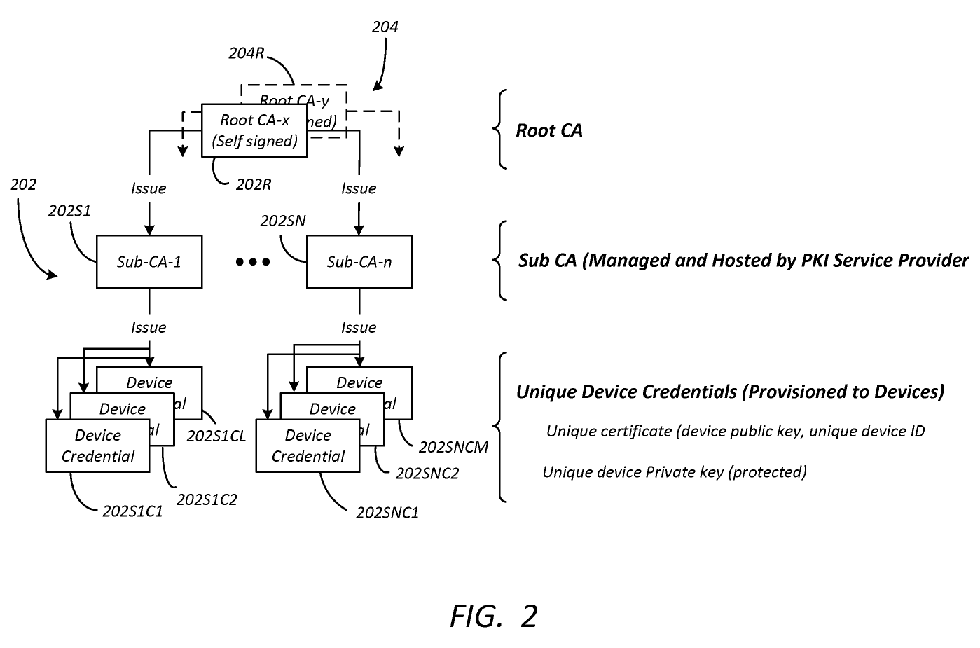

FIG. 2 is an illustration of multiple PKI certificate hierarchical structures (hereby alternatively referred to as certificate hierarchies). The illustrated certificate hierarchies include a first certificate hierarchy 202 and a second certificate hierarchy 204.

At the top of each certificate hierarchy 202, 204 is root certificate issued by a Root Certificate Authority (CA) 202R, which is a trusted entity that issues self-signed certificates. Below root CAs 202R are certificates issued by Intermediate CAs or subordinate CAs (sub CAs) 202S1 and 202S2 (collectively referred to hereinafter as sub CAs 202S), which act as intermediaries that issue certificates to end entities, such as devices 102. There could be multiple layers of sub CAs 202S between a root CA 202R and an end entity unique device credentials (DC), which include a unique device private key (which is protected) and a unique device certificate having a device public key corresponding to the device private key and a unique device ID. For brevity, in the following discussion, the term “root CA” may be used to refer to a certificate issued by the root CA 202R, and the term “sub CA” may be used to refer to the certificate issued by the sub CA 202S as is apparent from context.

Note that sub CA 202S1 may issue multiple device credentials 202S1C1, 202S1C2, and 202S1CL and sub CA 202SN may issue multiple device credentials 202SNC1, 202SNC2 and 202SNM. This hierarchical structure ensures that trust is anchored at the root CA 202R, and certificates issued by intermediate CAs 202S are trusted if the chain of trust leads back to the root CA 202R.

Each certificate hierarchy 202, 204 may comprise multiple certificate chains. A certificate chain is an order of elements of the certificate hierarchy extending from the Root CA through one Sub-CA to the next CA lower in the hierarchy, then to the next CA lower in the hierarchy, and so on down to the device 102 itself. For example, FIG. 2 illustrates six certificate chains, namely (1) a certificate chain comprising elements extending from the device credential 202S1C1, the Sub CA-1 202S1, and Root CA-x 202R (2) a second certificate chain comprising elements extending from the device credential 202S1C2, the Sub CA-1 202S1, and Root CA-x 202R, (3) a third chain comprising elements extending from the device credential 202S1C3, the Sub CA-1 202S1, and Root CA-x 202R, (4) a fourth chain comprising elements extending from the device credential 202SNC1, the Sub CA-n 202SN, and Root CA-x 202R, (5) a fifth chain comprising elements extending from the device credential 202SNC2, the Sub CA-n 202SN, and Root CA-x 202R, and (6) and a sixth chain comprising elements extending from the device credential 202SNCM, the Sub CA-n 202SN, and Root CA 202R.

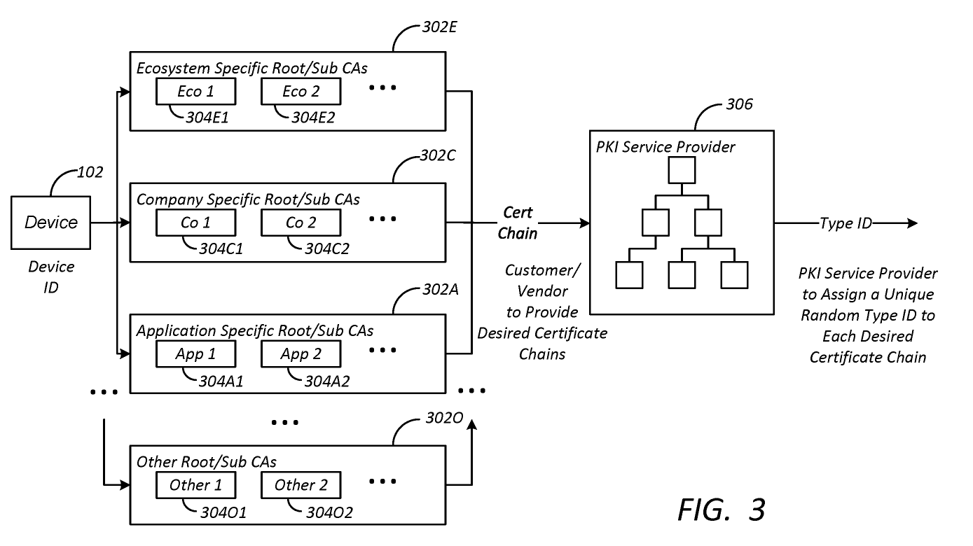

Notably, the first certificate hierarchy 202 may comprise an ecosystem specific certificate hierarchy, the second certificate hierarchy 204 may comprise a company specific certificate hierarchy, and other certificate hierarchies such as one or more application specific certificate hierarchies may be included, as also illustrated in FIG. 3.

An end entity certificate for a device 102 typically contains the device credential, which includes a device ID and optionally a set of device attributes. The device ID may be associated with the device hardware, such as unique serial number, or may be a non-hardware related device ID, such as a unique device name assigned after the device 102 is put into operation. Optional device attributes might include information such as device manufacturer, manufacturing date, model number, and device owner.

Different domains may need different kinds of device credentials. Therefore, multiple device certificates of the same device 102 would typically include different device credentials. In addition, the validity period of different device certificates for different domains may be of different temporal lengths.

Because the device ID of the device 102 is included in the certificate, another element of a domain the device is in can use the root CA and intermediate CA(s) of that certificate to verify the authenticity of the device ID.

Using certificates to carry devices IDs can reduce the number of SKUs used to track devices with the same hardware but needing different device credentials for multi-domain deployment at any manufacturing, transfer, or deployment time.

### Configuration of Multiple PKI Structures with Random Unique type IDs

In the discussion that follows, a framework is defined that uses a generic PKI structure configurations and allows PKI service customers (device manufacturers, operators, etc.) to obtain different kinds of certificates for their devices 102. Through this process, and the use of random, unique type IDs, PKI service customers (e.g., device manufacturers, service providers and the like) can configure multiple PKI structures for different domains where their devices 102 are deployed to.

As shown in FIG. 2, a PKI structure can contain one or more certificate chains. For each certificate chain configured, random provision parameter such as a random unique data type ID (aka type ID) is assigned to represent the chain and to be used in device certificate provisioning. Using a data type ID that is random makes it hard for a rogue player to obtain device certificates from the PKI service provider by guessing a valid data type ID.

FIG. 3 is a diagram illustrating multiple certificate chains such as certificate chains 202, 204 being mapped one-to-one to a random unique data type IDs by a PKI service provider 306. As illustrated, a device 102 may require credentials to operate with a variety of different systems 302, which may include different ecosystems 302E, different companies 302C, and different applications 302A, or other different systems 302O. Each such ecosystem may have ecosystem Root CAs and Sub-CAs. For example, there may be Root CAs and Sub-CAs that are part of a first ecosystem 304E1 (e.g., APPLE) and Root CAs and Sub-CAs that are part of a second ecosystem 304E2 (e.g., GOOGLE). Similarly, each company specific system 302C may include Root CAs and Sub-CAs that are used by the first company 304C1 such as WALMART, and Root CAs and Sub-CAs that are used by a second company 304C2 such as COSTCO. Further, each application specific system 302A may include Root CAs and Sub-CAs that are used by a first application 304A1 such as a medical application and a second application 304A2 such as an energy application 304A2. Similarly, each other system 302O may include Root CAs and Sub-CAs that are used by a first system 304O1 and Root CAs and Sub-CAs that are used by second system 304O2. Information regarding the Root CAs and Sub-CAs or desired Root CAs and Sub-CAs that define a desired certificate chain is provided by the respective system vendors or customers to the PKI service provider 306, which accepts this information and generates a single, random unique value type ID to be associated with that certificate chain.

The result is that when the device 102 requires a credential from a particular ecosystem, company, or for a particular application, the PKI service provider 306 accepts a request for the certificate that includes the type ID and provides the credentials associated with the certificate chain identified by that type ID.

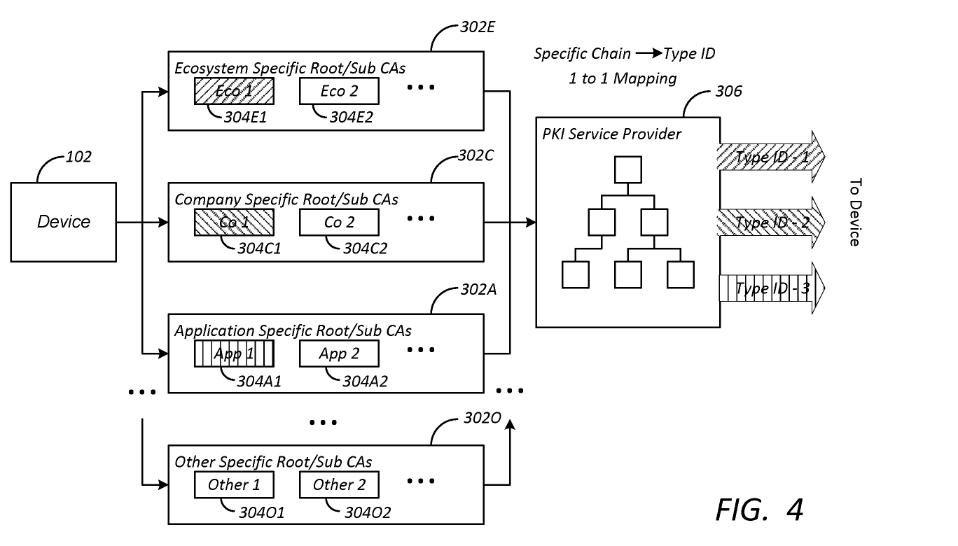

FIG. 4 is a diagram illustrating this operating principle. A device 102 such as a smartwatch desires credentials from first ecosystem Eco 1 304E1 and first company Co1 304C1, as well as credentials to run application 304A1. The chain of credentials that are required in each case has been provided to the PKI service provider 306. The PKI service provider 306 generates a configuration package associated with each such chain of credentials, and associates with a unique data type ID (in the illustrated case, Type ID-1, Type ID-2, and Type ID-3) with each configuration package. Those data type IDs are provided to the device 102, thus allowing the device to specify the requested credential and the associated chain of credentials by using the type ID.

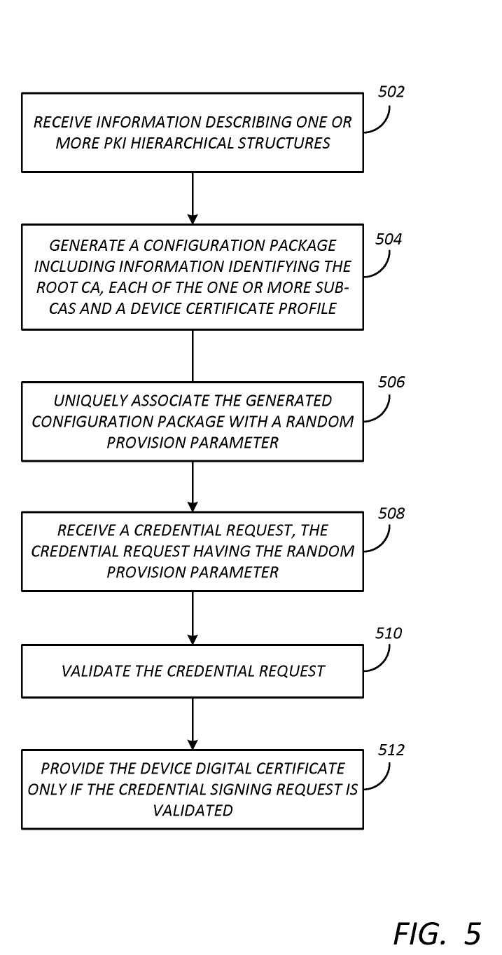

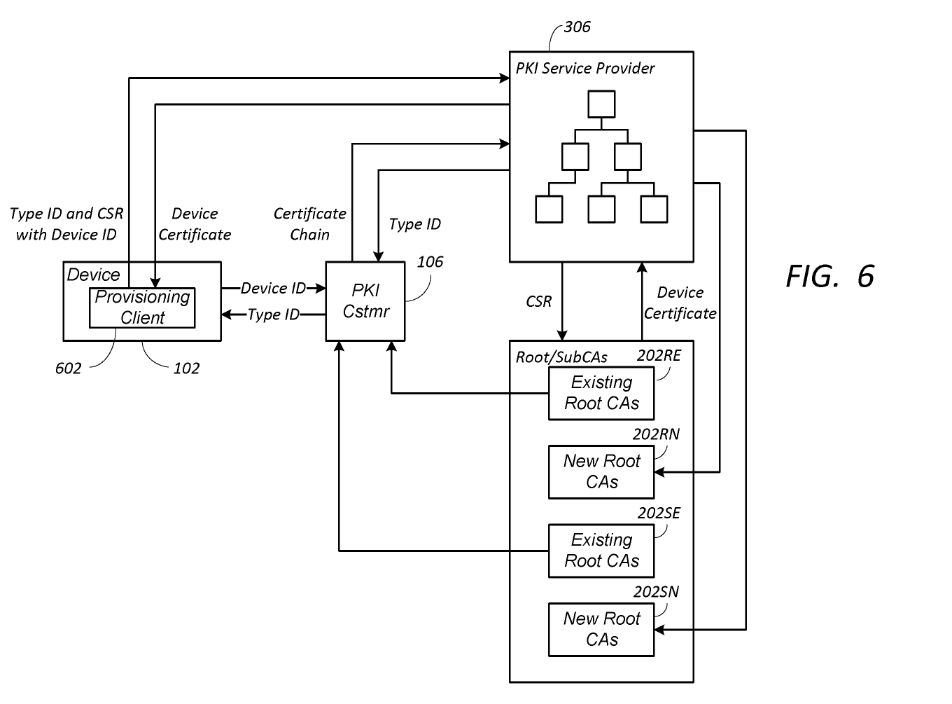

FIG. 5 is a diagram illustrating one embodiment of exemplary operations that can be used to provision digital certificates to a device 102. FIG. 5 will be discussed in connection with FIG. 6, which presents a diagram illustrating the flow of information between the PKI customer 106, the PKI Service Provider 306, Root CAs 202R and Sub-CAs 202S, and the device 102.

In block 502, the PKI service provider 306 receives information describing one or more PKI hierarchical structures such as PKI hierarchical structure 202 from the PKI customer 106. The PKI hierarchical structure 202 comprises one or more certificate chains 202, each of which includes a Root CA 202R certificate, one or more Sub CA 202S certificates, and a device certificate 202S1C1.

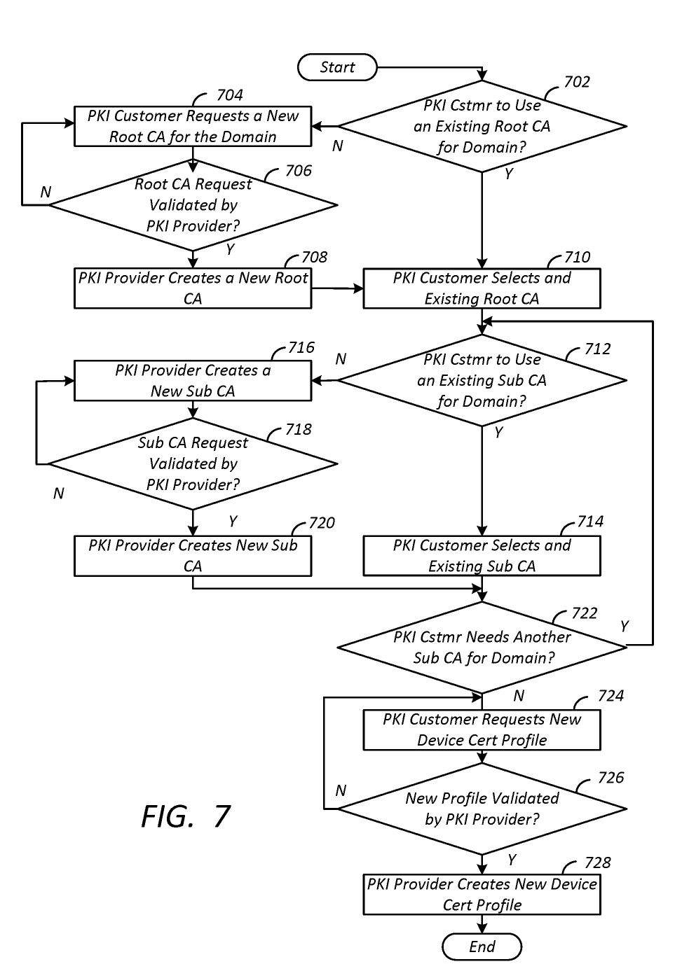

FIG. 7 is a diagram depicting one embodiment of exemplary operations that can be used to receive information describing the PKI hierarchical structure 202. Initially a PKI customer 106 (e.g., manufacturer or supplier of the devices 102 that need digital certificates) determines that they need to define a certificate chain to a device 102. Generally, that certificate chain may use an existing Root CA 202RE (certificate) for the domain or a new Root CA 202RN (certificate). As shown in block 702, the PKI service provider 306 may inquire the PKI customer 106 as to whether the certificate chain that is desired includes a pre-existing Root CA 202RE (certificate). If so, block 702 directs processing to block 710, the PKI customer 106 selects an existing Root CA 202RE, and processing is routed to block 712. If not, block 702 directs processing to block 704, and the PKI customer 106 requests a new Root CA 202RN for the domain of the desired PKI hierarchical structure. In block 706, the PKI service provider 306 attempts to validate Root CA request. Typically, ecosystems have requirements before issuing a root CA certificate, such as verifying the requestor’s membership in the consortium for the ecosystem. Validation of the request assures that these requirements are satisfied.

If the request for a Root CA certificate cannot be validated, processing returns to block 704, and the PKI customer 106 is given the opportunity to update the request. If the request for a Root CA certificate is validated by the PKI service provider 306, the PKI service provider 306 creates a new Root CA 202RN certificate, and processing is routed to block 712.

In one embodiment, a PKI service provider 306 may act as an agent for the customer and request a new Root CA from a third party. This can occur when the PKI service provider 306 serving the customer is not a CA issuer and needs to ask another PKI service provider who is a root CA certificate issuer to create a root CA certificate for the customer. Other embodiments for establishing a chain also exist, for example, a consortium may have a one and only root CA certificate for all of its members, and all of the members or PKI service providers on behalf of members would need to request sub CAs certificates from the operator of the root CAs.

Block 712 determines if the PKI customer 106 wishes to use an existing SubCA 202SE certificate in the definition of the certificate chain. If so, processing is routed to 714, which allows the PKI customer 106 to select the existing Sub CA 202SE certificate. Processing is thereafter routed to block 722.

If the PKI customer 106 does not wish to use an existing Sub CA 202SE certificate in the definition of the certificate chain of the PKI hierarchical structure, processing is routed to block 716, where the PKI customer 106 requests a new Sub CA 202SN certificate for the PKI hierarchy below the Root CA 202R certificate in the certificate chain. In block 718, the PKI service provider 306 receives the request and validates the request for a new Sub CA 202SN certificate. If the request cannot be validated, processing is routed to block 716, and the PKI customer 106 is notified and may modify the request or make a new request for a different Sub CA 202SN. If the request can be validated, processing is routed to block 720, and the PKI service provider 306 creates a new Sub CA 202SN, and processing is routed to block 722.

The validation process includes examining the information submitted by the PKI customer 106 for the requested new sub CA. If desired, a sample may be presented to the PKI customer 106 in aiding the specification of the requisite information. The PKI service provider 306 then examines that submitted information to determine whether it is unique (e.g., this is a request for a new sub CA). If the information is not unique, the PKI customer 106 is asked to re-enter the requested information. If the information submitted is unique, a vetting officer (VO) or the PKI service provider 306 reviews the submitted information to determine if the request meets requirements. For example, if it is a request associated with Connectivity Standards Alliance (CSA) requirements, that the ID submitted is a valid ID). This can be determined by VO referencing the CSA website. If the request does not meet requirements, the PKI customer 106 is informed. If the request meets requirements, a key ceremony can be performed to generate a key ceremony package (KCP). The PKI service provider 306 then internally creates the required credentials (a private key and a certificate having a public key associated with the private key) off line. For a sub CA that is hierarchically the next level above the device certificate, the private key is available in the online system, because that private key is needed to respond to certificate signing requests from the device. For sub CAs above that level, the private key remains in the off line system, while the certificate having the public key is uploaded to the online system. The requested certificate is then reviewed by the VO and security trained personnel in the PKI service provider, and if approved, the requested certificate is made available.

Block 722 determines if the PKI customer’s desired certificate chain includes at least one more Sub CA 202A. If so, processing is routed to block 712, and the logic that follows identifies an existing Sub CA 202SE or creates a new SubCA 202SN to satisfy the request. This process is repeated until the PKI customer 106 does not need additional Sub CAs 202S in the desired certificate chain, at which time, processing is routed to block 724.

In block 724, the PKI customer 106 (which may be a vendor of the device 102) requests a new device certificate profile. A device credential profile can be thought of as a template that defines what attributes should be included in certificates, and may optionally indicate desired formats and/or value ranges for these attributes. For example, the profile of certificates for a fitness tracker made by company XYZ may stipulate that the certificates must have an “O” attribute and the value of that attribute must be “XYZ.” It is also possible to include a device class as a specified attribute in the device credential profile. The credential profile request includes information sufficient to identify the device for which the credentials are requested, for example, a device identifier.

Block 726 depicts the PKI service provider 306 attempting to validate the requested new device profile. An ecosystem may require root CAs to have certain attributes, sub CAs to have certain attributes, and device certificate to have certain attributes. When a PKI customer requests a root CA, a sub CA, or a device cert profile, its PKI service provider 306 must check the requested root/sub CA or device cert profile against the requirements of the relevant ecosystem. For example, CSA Matter device attestation certificates (DACs), a kind of device certificate, must have two special OID (Object Identifiers) attributes. A first OID (1.3.6.1.4.1.57239.1.1) must contain the device’s vendor’s vendor ID, and a second OID (1.3.6.1.4.1.57239.1.2) must contain the device’s product ID. Therefore, a cert profile request from a Matter device vendor for a type of device must indicate that the desired cert profile for that type of devices includes those two OIDs and what their values are. If a cert profile request does not say that the desired cert profile includes both OIDs, the request is not validated.

When a device later submits a credential request, the parameters of the request are checked against the attributes of the device profile. If the format or content of the parameters of the request do not match the device profile, the request is not validated and the requested credential or signing of the device certificate will not be provided.

If validation does not succeed, processing is routed back to block 724, and the PKI customer 106 may request a new device certificate profile with different or modified parameters. If the validation succeeds, processing is routed to block 728, in which the PKI provider creates a new device profile. At this point, the PKI customer 106 has provided information defining a certificate chain to the PKI service provider 306.

Returning to FIG. 5, the PKI service provider 306 responds by generating a configuration package that includes or describes the chain of the root CA and sub CAs and a device certificate profile specified above, as shown in block 504. After the PKI service provider generates the configuration package, the PKI service provider’s system automatically assigns a single, unique random provision parameter such as the data type ID to that configuration package, as shown in block 506. This associates the configuration package with that data type ID, such that a one-to-one relationship is established between the configuration package and the data type ID such that the data type ID is associated with only one configuration package, and the configuration package is associated with only one data type ID.

The PKI customer 106 obtains the type ID associated with the generated configuration package. The PKI customer 106 is able to obtain that data type ID from the PKI service provider system directly, or in an email or other message from the PKI service provider 306. Typically, the PKI service provider sends the data type ID to the PKI customer after it is generated, but the data type ID may instead be sent to the PKI customer in response to a request from the PKI customer.

The PKI customer 106 can repeat the above process to configure a different certificate chain for a different kind of device (or different device). The PKI service provider 306 is preconfigured to ask for information required by a domain when a new Root CA 202RN, new Sub-CA 202SN or new device certificate profile is requested. Such domain-specific pre-configurations enable PKI service customers 106 to submit all necessary when they request a new Root CA 202RN, new Sub CA 202SN, or new device profile.

Once a configuration package has been generated and associated with a unique data type ID, the PKI service provider 306 is prepared to respond to request for device credentials for that data type ID. The unique data type ID that is assigned to a particular certificate chain is used when a device 102 needs to be provisioned with a device certificate in that certificate chain.

When a PKI customer 106 needs to obtain a particular device certificate for a device 102, a certificate provisioning client 602 sends a credential request to the PKI service provider 304, which receives the request as illustrated in block 508 of FIG. 5. The provisioning client 602 may be, for example, a software program running within the target device 702 within the PKI customer 106 or otherwise external to the target device 102.

In one embodiment, the credential request includes a certificate signing request (CSR) that contains an identifier of the device for which credentials are requested (e.g., a device ID) and the data type ID, wherein the data type ID is uniquely associated with the desired certificate chain. The CSR may also include optional device attributes that, together with the device’s ID, make up a device credential.

In another embodiment, the credential request is a request for a certificate and a private key, and the request includes a set of attributes to be included in a device certificate, one of which is an identifier of the device, and the data type ID, wherein the data type ID is uniquely associated with the desire certificate chain.

The PKI service provider 306 validates the format of the device ID and any device attributes in the credential request against the device certificate profile in the configuration package identified by the data type ID in the same credential request, as shown in block 510. If the validation process passes, the PKI service provider 306 generates and returns a credential response.

The credential response comprises the requested signed device certificate (if the request is a certificate signing request) with that device ID and any device attributes, or a device certificate and a private key corresponding to the public key in a device certificate (if the request is for a device certificate), sometimes accompanied by some or all of its upper level root certificates and sub CA certificates. This is illustrated in block 512. The certificate provisioning client 602 then installs the certificate on the device 102.

The credential request may be received directly from the device 102, the PKI customer 106, or an entity that is managing or operating with the device 102 (e.g., the device manufacturer or an entity that wishes to provide services to the device 102), either prompted by a request by the device or otherwise.

### Hardware Environment

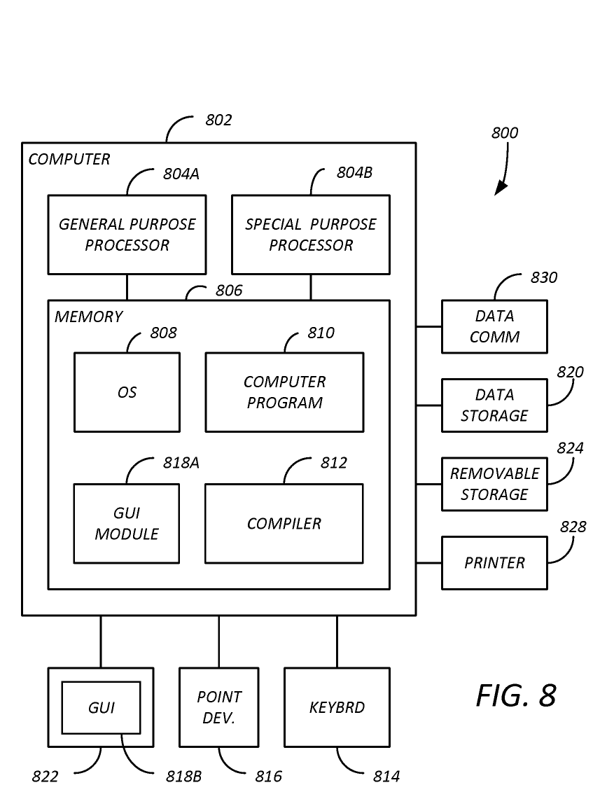

FIG. 8 illustrates an exemplary computer system 800 that could be used to implement processing elements of the above disclosure, including the device 102, processors disposed at the PKI customer 106 or the PKI service provider 306, or any of the processors computing the processing threads. The computer 802 comprises a processor 804 and a memory, such as random access memory (RAM) 806. The computer 802 is operatively coupled to a display 822, which presents images such as windows to the user on a graphical user interface 818B. The computer 802 may be coupled to other devices, such as a keyboard 814, a mouse device 816, a printer 828, etc. Of course, those skilled in the art will recognize that any combination of the above components, or any number of different components, peripherals, and other devices, may be used with the computer 802.

Generally, the computer 802 operates under control of an operating system 808 stored in the memory 806, and interfaces with the user to accept inputs and commands and to present results through a graphical user interface (GUI) module 818A. Although the GUI module 818A is depicted as a separate module, the instructions performing the GUI functions can be resident or distributed in the operating system 808, the computer program 810, or implemented with special purpose memory and processors. The computer 802 also implements a compiler 812 which allows an application program 810 written in a programming language such as COBOL, C++, FORTRAN, or other language to be translated into processor 804 readable code. After completion, the application 810 accesses and manipulates data stored in the memory 806 of the computer 802 using the relationships and logic that was generated using the compiler 812. The computer 802 also optionally comprises an external communication device such as a modem, satellite link, Ethernet card, or other device for communicating with other computers.

In one embodiment, instructions implementing the operating system 808, the computer program 810, and the compiler 812 are tangibly embodied in a computer-readable medium, e.g., one or more data storage devices 820, which could include one or more fixed or removable data storage devices 824, such as a zip drive, floppy disc drive, hard drive, CD-ROM drive, tape drive, etc. Further, the operating system 808 and the computer program 810 are comprised of instructions which, when read and executed by the computer 802, causes the computer 802 to perform the operations herein described. Computer program 810 and/or operating instructions may also be tangibly embodied in memory 806 and/or data communications devices 830, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### Conclusion

This concludes the description of the preferred embodiments of the present disclosure.

A method for provisioning a device credential is disclosed. In one embodiment, the method comprises: receiving information describing a PKI hierarchical structure of the one or more PKI hierarchical structures, the PKI hierarchical structure having chain of credentials having a root certificate authority (CA) certificate, one or more subordinate CA certificates, and a device certificate; generating a configuration package having information identifying the root CA; information identifying each of the one or more subordinate CAs; and a device certificate profile. The method also comprises uniquely associating the configuration package with a random provision parameter; receiving a request for a credential comprising the random provision parameter; validating the request for the credential; and providing the credential only if the request for the credential is validated.

Implementations may include one or more of the following features.

Any of the above methods, wherein: the credential request comprises a certificate signing request (CSR); and the credential comprises a signed device certificate.

Any of the above methods, wherein: the credential request comprises a set of attributes to be included in the device certificate, including the random provision parameter.

Any of the above methods, wherein: the information describing PKI hierarchical structure received from a device vendor; and the unique random provision parameter associated with the configuration package is transmitted to device vendor.

Any of the above methods, wherein receiving information describing a PKI hierarchical structure comprises receiving information describing the root CA certificate; receiving information describing the subordinate CA certificate; and receiving information describing a device certificate profile.

Any of the above methods, wherein: the information describing the root CA certificate describes an existing root CA certificate; and the information describing the subordinate CA certificate describes an existing subordinate CA certificate.

Any of the above methods, wherein: the information describing the root CA certificate describes a new root CA certificate; the method further comprises: validating the described new root CA certificate; creating the described new root CA certificate only if the described new root CA certificate is validated; and wherein the information describing the subordinate CA certificate describes a new subordinate CA certificate and the method further comprises: validating the described new subordinate C certificate; and creating the described new subordinate CA certificate only if the described new subordinate CA is validated.

Any of the above methods, wherein the configuration package further comprises: a vendor identifier (ID); and a product ID.

Any of the above methods, wherein: the credential request further includes an ID of the device.

Any of the above methods, wherein: the random provision parameter is selected from a plurality of random provision parameters, each of the plurality of random provision parameters: being associated a different batch of devices and a different kind of credential than the other of the plurality of random provision parameters; and thereby distinguishing different batches of devices without use of a stock keeping unit.

Another embodiment is evidenced by a system for provisioning a device credential. In one embodiment, the system comprises a processor and a memory, the memory storing processor instructions comprising processor instructions for: receiving information describing a PKI hierarchical structure of the one or more PKI hierarchical structures, the PKI hierarchical structure having chain of credentials having a root certificate authority (CA) certificate, one or more subordinate CA certificates, and a device certificate; generating a configuration package; uniquely associating the configuration package with a random provision parameter; receiving a request for a credential comprising the random provision parameter; validating the request for the credential; and providing the credential only if the request for the credential is validated, wherein the configuration package comprises information identifying the root CA; information identifying each of the one or more subordinate CAs; and a device certificate profile.

Implementations may include one or more of the following features.

Any of the above systems, wherein: the credential request comprises a certificate signing request (CSR); the credential comprises a signed device certificate.

Any of the above systems, wherein: the credential request comprises a set of attributes to be included in the device certificate, including the random provision parameter and the information describing PKI hierarchical structure received from a device vendor; and the unique random provision parameter associated with the configuration package is transmitted to device vendor.

Any of the above systems, wherein: wherein the processor instructions for receiving information describing a PKI hierarchical structure comprise processor instructions for: receiving information describing the root CA certificate; receiving information describing the subordinate CA certificate; and receiving information describing a device certificate profile.

Any of the above systems, wherein: the information describing the root CA certificate describes an existing root CA certificate; and the information describing the subordinate CA certificate describes an existing subordinate CA certificate.

Any of the above systems, wherein: the information describing the root CA certificate describes a new root CA certificate; the processor instructions further comprise processor instructions for: validating the described new root CA certificate; creating the described new root CA certificate only if the described new root CA certificate is validated. Also, the information describing the subordinate CA certificate describes a new subordinate CA certificate, and the processor instructions further comprise processor instructions for: validating the described new subordinate certificate.

Any of the above systems, wherein: the configuration package further comprises a vendor identifier (ID); and a product ID.

Any of the above systems, wherein: the credential request further includes an ID of the device.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. In a system having a device and one or more public key infrastructure (PKI) hierarchical structures, a method of provisioning a device credential, comprising:
receiving information describing a PKI hierarchical structure of the one or more PKI hierarchical structures, the PKI hierarchical structure having chain of credentials having a root certificate authority (CA) certificate, one or more subordinate CA certificates, and a device certificate;
generating a configuration package having:
information identifying the root CA;
information identifying each of the one or more subordinate CAs; and
a device certificate profile;
uniquely associating the configuration package with a random provision parameter;
receiving a request for a credential comprising the random provision parameter;
validating the request for the credential; and
providing the credential only if the request for the credential is validated.

2. The method of claim 1, wherein:
the credential request comprises a certificate signing request (CSR);
the credential comprises a signed device certificate.

3. The method of claim 1, wherein:
the credential request comprises a set of attributes to be included in the device certificate, including the random provision parameter.

4. The method of claim 1, wherein:
the information describing PKI hierarchical structure received from a device vendor; and
the unique random provision parameter associated with the configuration package is transmitted to device vendor.

5. The method of claim 1, wherein receiving information describing a PKI hierarchical structure comprises:
receiving information describing the root CA certificate;
receiving information describing the subordinate CA certificate; and
receiving information describing a device certificate profile.

6. The method of claim 5, wherein:
the information describing the root CA certificate describes an existing root CA certificate; and
the information describing the subordinate CA certificate describes an existing subordinate CA certificate.

7. The method of claim 5, wherein
the information describing the root CA certificate describes a new root CA certificate;
the method further comprises:
validating the described new root CA certificate;
creating the described new root CA certificate only if the described new root CA certificate is validated;
the information describing the subordinate CA certificate describes a new subordinate CA certificate;
the method further comprises:
validating the described new subordinate C certificate;
creating the described new subordinate CA certificate only if the described new subordinate CA is validated.

8. The method of claim 5, wherein the configuration package further comprises:
a vendor identifier (ID); and
a product ID.

9. The method of claim 5, wherein the credential request further includes:
an ID of the device.

10. The method of claim 1, wherein:
the random provision parameter is selected from a plurality of random provision parameters, each of the plurality of random provision parameters:
being associated a different batch of devices and a different kind of credential than the other of the plurality of random provision parameters; and
thereby distinguishing different batches of devices without use of a stock keeping unit.

11. In a system having a device and one or more public key infrastructure (PKI) hierarchical structures, an apparatus for provisioning a device credential, comprising:
a processor;
a memory, storing processor instructions comprising processor instructions for:
receiving information describing a PKI hierarchical structure of the one or more PKI hierarchical structures, the PKI hierarchical structure having chain of credentials having a root certificate authority (CA) certificate, one or more subordinate CA certificates, and a device certificate;
generating a configuration package having:
information identifying the root CA;
information identifying each of the one or more subordinate CAs; and
a device certificate profile;
uniquely associating the configuration package with a random provision parameter;
receiving a request for a credential comprising the random provision parameter;
validating the request for the credential; and
providing the credential only if the request for the credential is validated.

12. The apparatus of claim 11, wherein:
the credential request comprises a certificate signing request (CSR);
the credential comprises a signed device certificate.

13. The apparatus of claim 11, wherein:
the credential request comprises a set of attributes to be included in the device certificate, including the random provision parameter.

14. The apparatus of claim 11, wherein:
the information describing PKI hierarchical structure received from a device vendor; and
the unique random provision parameter associated with the configuration package is transmitted to device vendor.

15. The apparatus of claim 1, wherein the processor instructions for receiving information describing a PKI hierarchical structure comprise processor instructions for:
receiving information describing the root CA certificate;
receiving information describing the subordinate CA certificate; and
receiving information describing a device certificate profile.

16. The apparatus of claim 15, wherein:
the information describing the root CA certificate describes an existing root CA certificate; and
the information describing the subordinate CA certificate describes an existing subordinate CA certificate.

17. The apparatus of claim 15, wherein
the information describing the root CA certificate describes a new root CA certificate;
the processor instructions further comprise processor instructions for:
validating the described new root CA certificate;
creating the described new root CA certificate only if the described new root CA certificate is validated;
the information describing the subordinate CA certificate describes a new subordinate CA certificate;
the processor instructions further comprise processor instructions for:
validating the described new subordinate certificate;
creating the described new subordinate CA certificate only if the described new subordinate CA is validated.

18. The apparatus of claim 15, wherein the configuration package further comprises:
a vendor identifier (ID); and
a product ID.

19. The apparatus of claim 15, wherein the credential request further includes:
an ID of the device.

20. In a system having a device and one or more public key infrastructure (PKI) hierarchical structures, an apparatus of provisioning a device credential, comprising:
means for receiving information describing a PKI hierarchical structure of the one or more PKI hierarchical structures, the PKI hierarchical structure having chain of credentials having a root certificate authority (CA) certificate, one or more subordinate CA certificates, and a device certificate;
means for generating a configuration package having:
information identifying the root CA;
information identifying each of the one or more subordinate CAs; and
a device certificate profile;
means for uniquely associating the configuration package with a random provision parameter;
means for receiving a request for a credential comprising the random provision parameter;
means for validating the request for the credential; and
means for providing the credential only if the request for the credential is validated.
